(19) United States
(12) Patent Application Publication
(10) Pub. No.: US 2007/0130944 A1
(43) Pub. Date: Jun. 14, 2007

(54) Multi-Axis Turbocharger

(76) Inventors: Bradley Pelletier, Anthem, AZ (US); Robert Bruce Griggs, Sonoma, CA (US); Gary Hoffman, Bedford, NH (US)

Correspondence Address: Bradley Pelletier, 40517 N. Hawk Ridge Trail, Anthem, AZ, 85086, US

(21) Appl. No.: 11/164,918

(22) Filed: Dec. 10, 2005

(51) Int. Cl. F02B 33/44

(52) U.S. Cl. 60/605.1; 60/598

(57) ABSTRACT

A method for improving compressor/exhaust turbine efficiency's due to better application and control of turbines created by multiple stages.

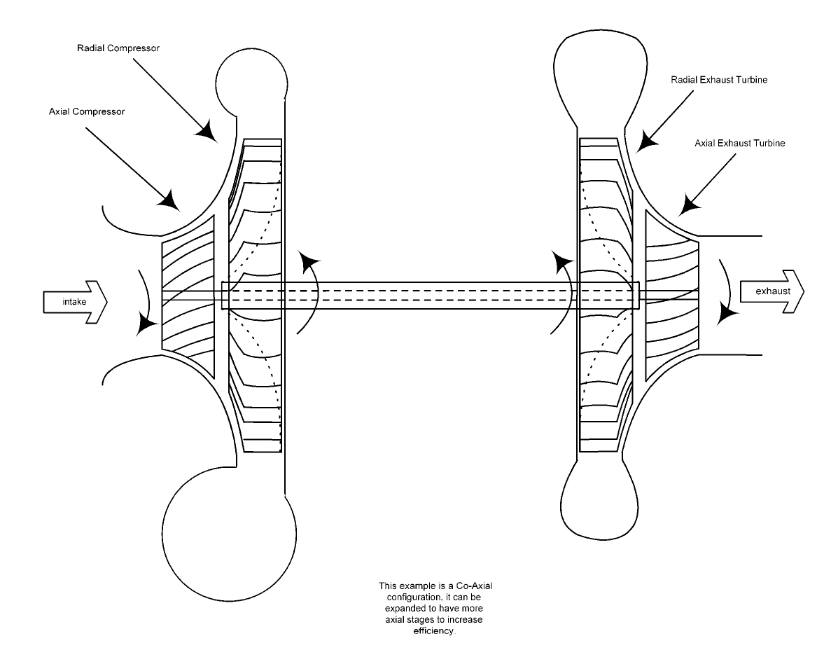

The present invention relates generally to turbocharged engines and, more particularly, to a system and method to improve the pumping efficiency of turbochargers.

### BACKGROUND OF THE INVENTION

Turbochargers are well known. Examples of turbochargers are produced by Honeywell Garrett and are presently being commercially marketed.

### SUMMARY OF THE INVENTION

It's the primary objective of the present invention to provide a new and improved turbocharger system. Advantageously, the turbocharger system may be easily installed and maintained while providing highly reliable and dependable use over a long service life. Still another objective of the present invention is to provide a turbocharger system exhibiting substantially increased efficiency, beyond that presently available with state of the art turbocharger systems.

What is claimed is:

1. Through application of existing Turbo-Jet/Turbo-Fan technologies the system take's advantage of the higher efficiency offered by these technologies. The system directly replaces current turbocharger systems.
